(19) United States
(12) Patent Application Publication
(10) Pub. No.: US 2024/0014886 A1
(43) Pub. Date: Jan. 11, 2024

(54) Signaling Over Satellite Access In Mobile Communications

(71) Applicant: MediaTek Singapore Pte. Ltd., Singapore (SG)

(72) Inventors: Marko Niemi, Oulu (FI); Yuan-Chieh Lin, Hsinchu City (TW); Guillaume Sebire, Oulu (FI); Per Johan Mikael Johansson, Kungsangen (SE)

(21) Appl. No.: 18/203,649

(22) Filed: May 31, 2023

Related U.S. Application Data
(60) Provisional application No. 63/367,731, filed on Jul. 6, 2022.

(51) Int. Cl. H04B 7/185

(52) U.S. Cl. CPC H04B 7/18513; H04B 7/18519

(57) ABSTRACT

Examples pertaining to improvement to signaling over satellite access in mobile communications are described. A user equipment (UE) initiates a procedure with a cell of a network over a satellite access. In response, the UE receives a message from the network indicating that the procedure cannot be completed due to an aspect of the satellite access. Then, the UE reattempts to complete the procedure responsive to a condition being met.

### CROSS REFERENCE TO RELATED PATENT APPLICATION(S)

The present disclosure is part of a non-provisional application claiming the priority benefit of U.S. Patent Application No. 63/367,731, filed 6 Jul. 2022, the content of which herein being incorporated by reference in its entirety.

### TECHNICAL FIELD

The present disclosure is generally related to mobile communications and, more particularly, to improvement to signaling over satellite access in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) standards including 5th Generation (5G) New Radio (NR) and 4th Generation (4G) Evolved Packet Service (EPS), some satellite constellations do not offer continuous connectivity via the satellite to the ground stations (GS). Even without continuous link to GS, if a satellite is equipped with eNB/gNB and core network elements, the satellite may offer a user equipment (UE) partial core network services as well as uplink (UL) and downlink (DL) data service (e.g., by implementing a store-and-forward (S&F) functionality in the satellite). However, for security and/or other reasons, the satellite may not contain subscriber information or security vectors for all devices/UEs. Therefore, there is a need for a solution of improvement to signaling over satellite access in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to improvement to signaling over satellite access in mobile communications. It is believed that the above-described issue(s) would be avoided or otherwise alleviated by implementing one or more of the proposed schemes described herein.

In one aspect, a method may involve a UE initiating a procedure with a cell of a network over a satellite access. The method may also involve the UE receiving a message from the network indicating that the procedure cannot be completed due to an aspect of the satellite access. The method may further involve the UE reattempting to complete the procedure responsive to a condition being met.

In another aspect, an apparatus may include a transceiver and a processor coupled to the transceiver. The transceiver may be configured to communicate wirelessly. The processor may initiate, via the transceiver, a procedure with a cell of a network over a satellite access. The processor may also receive, via the transceiver, a message from the network indicating that the procedure cannot be completed due to an aspect of the satellite access. The processor may further reattempt, via the transceiver, to complete the procedure responsive to a condition being met.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement to signaling over satellite access in mobile communications. According to the present disclosure, a number of possible solutions may be implemented separately or jointly. That is, although these possible solutions may be described below separately, two or more of these possible solutions may be implemented in one combination or another.

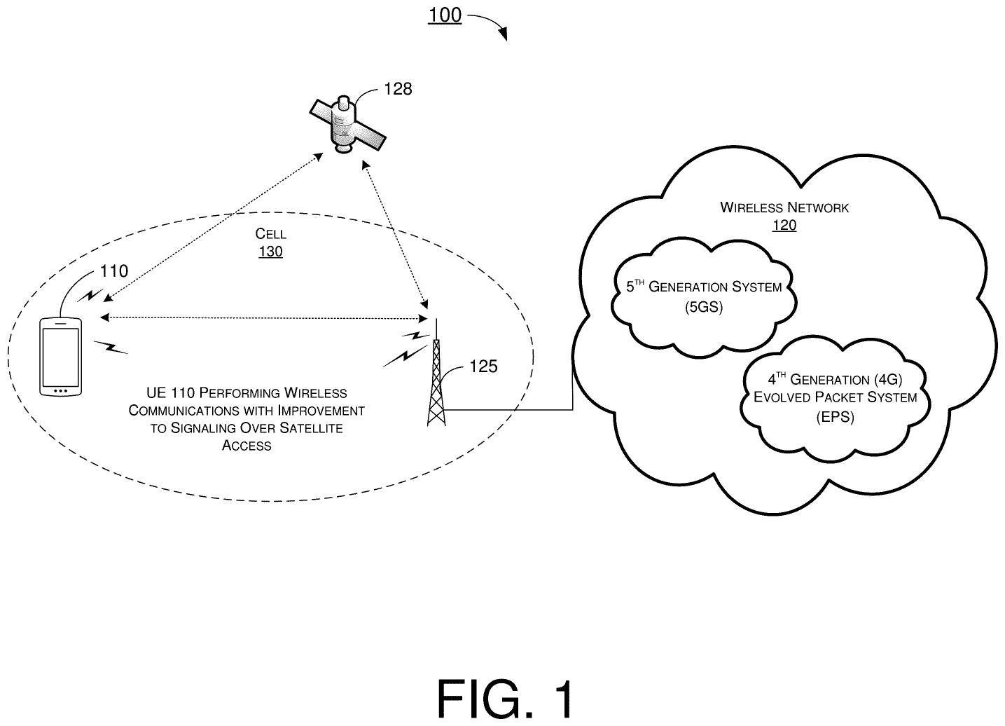

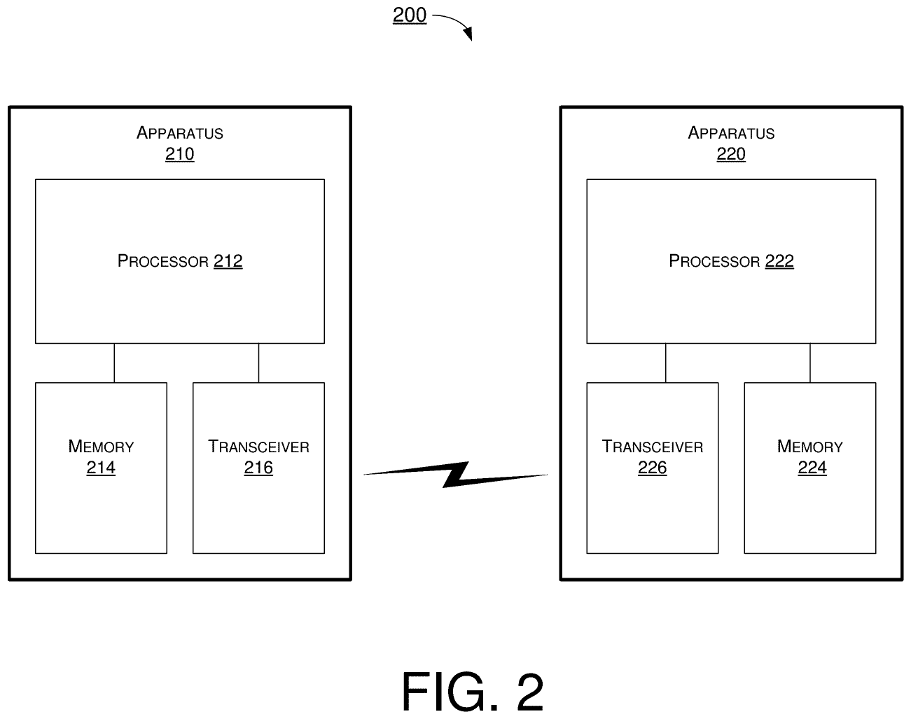

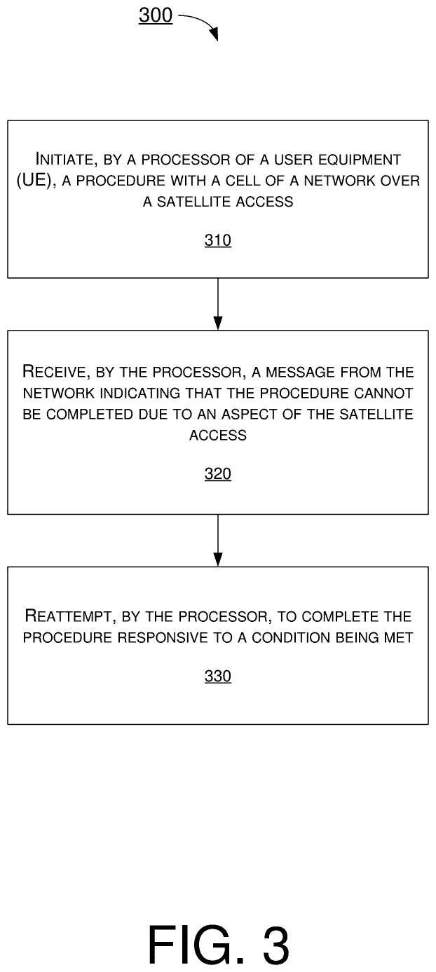

FIG. 1 illustrates an example network environment 100 in which various solutions and schemes in accordance with the present disclosure may be implemented. FIG. 2˜FIG. 3 illustrate examples of implementation of various proposed schemes in network environment 100 in accordance with the present disclosure. The following description of various proposed schemes is provided with reference to FIG. 1˜FIG. 3.

Referring to FIG. 1, network environment 100 may involve a UE 110 and a wireless network 120, which may include a 5^{th} Generation System (5GS) (and, optionally, an EPS). Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to improvement to signaling over satellite access in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly.

In view of aforementioned issues, in case that a UE (e.g., UE 110) is performing, for example, an initial registration (5G) or attach (4G) with a satellite, and the satellite is lacking ground station access, the initial procedure may need to be divided in two or more phases. In a first phase, the UE is allowed to start the procedure with the satellite and then, in the second phase, the UE is allowed to start the procedure again and then complete the procedure successfully. Between the first and second phases, the satellite does fetch necessary UE information via the ground station. In such case, the network (e.g., network 120) should have means to inform the UE that an ongoing procedure (e.g., the initial attach or registration procedure) is paused and will be continued in the next phase (e.g., in the next satellite/cell fly-over). Even if a satellite cell has a continuous link to ground station(s), an ongoing initial registration/attach procedure with the satellite cell may be interrupted when the UE initiates the registration/attach at a location nearby an edge of the cell and loses coverage of the cell as the UE moves away. In case that the network knows the current location of the satellite cell and the UE connected to it, the network should indicate to the UE that an ongoing procedure (e.g., initial attach or registration) cannot be completed due to discontinuous coverage (e.g., that the satellite is moving away). From such indication provided by the network, the UE can determine that the procedure can be restarted when access to the core network is available again. Accordingly, the present disclosure proposes various schemes to improve signaling over satellite access in mobile communications.

Under a proposed scheme in accordance with the present disclosure, in case that UE 110 initiates a non-access stratum (NAS) or access stratum (AS) procedure in network 120 through a satellite access via non-terrestrial network 128 (e.g., an initial attach or registration procedure), network 120 may send an indication via AS or NAS protocol to indicate to UE 110 that the procedure is stopped, paused, interrupted or rejected because the procedure cannot be completed due to UE 110 moving out of a cell coverage, due to discontinuous coverage or due to the satellite lacking UE information of UE 110. As reception of this indication, UE 110 may treat the procedure as not completed successfully but interrupted. Moreover, UE 110 may start (or auto-start) the same procedure when a corresponding suitable cell (from the same or different public land mobile network (PLMN) or from the same or different tracking area (TA)) is available again.

Under a proposed scheme in accordance with the present disclosure, in case of performing the procedure in a different PLMN or different TA requires an additional procedure, UE 110 may perform additional procedure(s) prior to performing the interrupted procedure. In case that UE 110 received some information from a network (e.g., network 120) during the procedure, UE 110 may store that information for future use in that network. Moreover, in the indication, network 120 may reject the procedure using an existing reject cause value (e.g., “congestion”) or a new cause value.

Under a proposed scheme in accordance with the present disclosure, with the indication, network 120 may inform UE 110 that the procedure is rejected due to one of the following reasons: (1) discontinuous coverage, (2) lack of coverage, and (3) lack of necessary UE information (e.g., lack of UE subscription, authorization or security information). At the time of indication, network 120 may also inform UE 110 about a time, a location and/or a TA (or cell) when and/or where UE 110 may reattempt the interrupted/stopped procedure. Alternatively, for enhanced security and to prevent malicious satellite to indicate inappropriate time (or time range), location(s), TA(s) and/or cell(s), and to allow a PLMN or home public land mobile network (HPLMN) to control the configurations of time, time range, location(s), TA(s) and/or cell(s), these configurations may be configured, stored or otherwise carried in a Universal Subscriber Identity Module (USIM) or in a management object (MO) (e.g., NAS configuration Open Mobile Alliance Management Object). The configured values may be used when network 120 indicates the procedure is rejected due to one of the aforementioned reasons.

Under a proposed scheme in accordance with the present disclosure, in case that a reject cause “congestion” (or a new cause) is used for indicating to UE 110 that the procedure over satellite access is interrupted, and that the message is non-integrity protected, network 120 may provide UE 110 with a short time (e.g., 15˜30 minutes) to inform UE 110 about a minimum time to wait before reattempting the procedure. For instance, in case that at expiry of the time the cell (or an allowable corresponding cell) is not available, UE 110 may start the procedure when a suitable cell becomes available. Moreover, in case that UE 110 receives a timer T3346 value over satellite access without integrity protection, UE 110 does not choose a T3346 value randomly from a default value range of 15˜30 minutes. Rather, UE 110 may start the timer with an exact timer value received from network 120.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to improvement to signaling over satellite access in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to improvement to signaling over satellite access in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 214 and memory 224 may include a U ICC.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., terrestrial network node 125 or non-terrestrial network node 128) of a wireless network (e.g., wireless network 120), is provided below.

Under certain proposed schemes in accordance with the present disclosure with respect to improvement to signaling over satellite access in mobile communications, processor 212 of apparatus 210, implemented in or as UE 110, may initiate, via transceiver 216, a procedure with a cell of a network over a satellite access. Moreover, processor 212 may receive, via transceiver 216, a message from the network indicating that the procedure cannot be completed due to an aspect of the satellite access. Furthermore, processor 212 may reattempt, via transceiver 216, to complete the procedure responsive to a condition being met.

In some implementations, the message may indicate that the procedure is rejected due to discontinuous coverage, lack of coverage, or lack of necessary UE information. In some implementations, the lack of necessary UE information may include lack of UE subscription, authorization or security information. In some implementations, the message may further indicate one or more of a time, a time range, a location, a TA and a cell when or where UE 110 can reattempt the procedure.

In some implementations, in reattempting, processor 212 may attempt using information configured in a USIM or MO. In some implementations, the information may indicate one or more of a time, a time range, a location, a TA and a cell when or where UE 110 can reattempt the procedure.

In some implementations, the message may a reject cause having a value corresponding to congestion to indicate to UE 110 that the procedure over the satellite access is interrupted. In some implementations, the message may be non-integrity protected. Moreover, the message may further indicate to UE 110 a minimum time to wait before reattempting the procedure. In such cases, in reattempting to complete the procedure responsive to the condition being met, processor 212 may, at expiry of a timer, start the procedure with the cell or another cell.

In some implementations, in receiving the message, processor 212 may receive the message over the satellite access without integrity protection, with the message providing a timer T3346 value. In such cases, in starting the procedure, processor 212 may perform certain operations. For instance, processor 212 may start a timer with the T3346 value provided by the network. Additionally, processor 212 may start the procedure at expiry of the timer.

In some implementations, the procedure may include an initial attach procedure or a registration procedure.

In some implementations, the message may indicate that the procedure is stopped, paused, interrupted or rejected before the procedure is completed due to UE 110 being out of cell coverage, discontinuous coverage or a satellite being lack of UE information.

In some implementations, in reattempting to complete the procedure responsive to the condition being met, processor 212 may start the procedure when another cell from a same or different PLMN or from a same or different TA is available. In some implementations, responsive to an additional procedure being required in an event of starting the procedure in a different PLMN or TA, in reattempting to complete the procedure, processor 212 may perform the additional procedure prior to performing the procedure.

In some implementations, the message may include an existing reject cause value or a new cause value to indicate to UE 110 that the procedure over the satellite access is rejected.

### Illustrative Processes

FIG. 3 illustrates an example process 300 in accordance with an implementation of the present disclosure. Process 300 may represent an aspect of implementing various proposed designs, concepts, schemes, systems and methods described above, whether partially or entirely, including those described above. More specifically, process 300 may represent an aspect of the proposed concepts and schemes pertaining to improvement to signaling over satellite access in mobile communications. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., terrestrial network node 125 or non-terrestrial network node 128) of a network (e.g., wireless network 120). Process 300 may begin at block 310.

At 310, process 300 may involve processor 212 of apparatus 210, implemented in or as UE 110, initiating, via transceiver 216, a procedure with a cell of a network over a satellite access. Process 300 may proceed from 310 to 320.

At 320, process 300 may involve processor 212 receiving, via transceiver 216, a message from the network indicating that the procedure cannot be completed due to an aspect of the satellite access. Process 300 may proceed from 320 to 330.

At 330, process 300 may involve processor 212 reattempting, via transceiver 216, to complete the procedure responsive to a condition being met.

In some implementations, the message may indicate that the procedure is rejected due to discontinuous coverage, lack of coverage, or lack of necessary UE information. In some implementations, the lack of necessary UE information may include lack of UE subscription, authorization or security information. In some implementations, the message may further indicate one or more of a time, a time range, a location, a TA and a cell when or where UE 110 can reattempt the procedure.

In some implementations, in reattempting, process 300 may involve processor 212 reattempting using information configured in a USIM or MO. In some implementations, the information may indicate one or more of a time, a time range, a location, a TA and a cell when or where UE 110 can reattempt the procedure.

In some implementations, the message may include a reject cause having a value corresponding to congestion to indicate to UE 110 that the procedure over the satellite access is interrupted. In some implementations, the message may be non-integrity protected. Moreover, the message may further indicate to UE 110 a minimum time to wait before reattempting the procedure. In such cases, in reattempting to complete the procedure responsive to the condition being met, process 300 may involve processor 212, at expiry of a timer, starting the procedure with the cell or another cell.

In some implementations, in receiving the message, process 300 may involve processor 212 receiving the message over the satellite access without integrity protection, with the message providing a timer T3346 value. In such cases, in starting the procedure, process 300 may involve processor 212 performing certain operations. For instance, process 300 may involve processor 212 starting a timer with the T3346 value provided by the network. Additionally, process 300 may involve processor 212 starting the procedure at expiry of the timer.

In some implementations, the procedure may include an initial attach procedure or a registration procedure.

In some implementations, the message may indicate that the procedure is stopped, paused, interrupted or rejected before the procedure is completed due to UE 110 being out of cell coverage, discontinuous coverage or a satellite being lack of UE information.

In some implementations, in reattempting to complete the procedure responsive to the condition being met, process 300 may involve processor 212 starting the procedure when another cell from a same or different PLMN or from a same or different TA is available. In some implementations, responsive to an additional procedure being required in an event of starting the procedure in a different PLMN or TA, in reattempting to complete the procedure, process 300 may further involve processor 212 performing the additional procedure prior to performing the procedure.

In some implementations, the message may include an existing reject cause value or a new cause value to indicate to UE 110 that the procedure over the satellite access is rejected.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating, by a processor of a user equipment (UE), a procedure with a cell of a network over a satellite access;
receiving, by the processor, a message from the network indicating that the procedure cannot be completed due to an aspect of the satellite access; and
reattempting, by the processor, to complete the procedure responsive to a condition being met.

2. The method of claim 1, wherein the message indicates that the procedure is rejected due to discontinuous coverage, lack of coverage, or lack of necessary UE information.

3. The method of claim 2, wherein the lack of necessary UE information comprises lack of UE subscription, authorization or security information.

4. The method of claim 2, wherein the message further indicates one or more of a time, a time range, a location, a tracking area (TA) and a cell when or where the UE can reattempt the procedure.

5. The method of claim 1, wherein the reattempting comprises reattempting using information configured in a Universal Subscriber Identity Module (USIM) or a management object (MO).

6. The method of claim 5, wherein the information indicates one or more of a time, a time range, a location, a tracking area (TA) and a cell when or where the UE can reattempt the procedure.

7. The method of claim 1, wherein the message comprises a reject cause having a value corresponding to congestion to indicate to the UE that the procedure over the satellite access is interrupted.

8. The method of claim 7, wherein the message is non-integrity protected, and wherein the message further indicates to the UE a minimum time to wait before reattempting the procedure.

9. The method of claim 8, wherein the reattempting to complete the procedure responsive to the condition being met comprises, at expiry of a timer, starting the procedure with the cell or another cell.

10. The method of claim 9, wherein the receiving of the message comprises receiving the message over the satellite access without integrity protection, wherein the message provides a timer T3346 value, and wherein the starting of the procedure comprises:
starting a timer with the T3346 value provided by the network; and
starting the procedure at expiry of the timer.

11. The method of claim 1, wherein the procedure comprises an initial attach procedure or a registration procedure.

12. The method of claim 1, wherein the message indicates that the procedure is stopped, paused, interrupted or rejected before the procedure is completed due to the UE being out of cell coverage, discontinuous coverage or a satellite being lack of UE information.

13. The method of claim 1, wherein the reattempting to complete the procedure responsive to the condition being met comprises starting the procedure when another cell from a same or different public land mobile network (PLMN) or from a same or different tracking area (TA) is available.

14. The method of claim 13, wherein, responsive to an additional procedure being required in an event of starting the procedure in a different PLMN or TA, the reattempting to complete the procedure further comprises performing the additional procedure prior to performing the procedure.

15. The method of claim 1, wherein the message comprises an existing reject cause value or a new cause value to indicate to the UE that the procedure over the satellite access is rejected.

16. An apparatus implementable in a user equipment (UE), comprising:
a transceiver configured to communicate wirelessly; and
a processor coupled to the transceiver and configured to perform, via the transceiver, operations comprising:
initiating, via the transceiver, a procedure with a cell of a network over a satellite access;
receiving, via the transceiver, a message from the network indicating that the procedure cannot be completed due to an aspect of the satellite access; and
reattempting, via the transceiver, to complete the procedure responsive to a condition being met.

17. The apparatus of claim 16, wherein the message indicates that the procedure is rejected due to discontinuous coverage, lack of coverage, or lack of necessary UE information, wherein the lack of necessary UE information comprises lack of UE subscription, authorization or security information, and wherein the message further indicates one or more of a time, a time range, a location, a tracking area (TA) and a cell when or where the UE can reattempt the procedure.

18. The apparatus of claim 16, wherein the reattempting comprises reattempting using information configured in a Universal Subscriber Identity Module (USIM) or a management object (MO), and wherein the information indicates one or more of a time, a time range, a location, a tracking area (TA) and a cell when or where the UE can reattempt the procedure.

19. The apparatus of claim 16, wherein the message comprises a reject cause having a value corresponding to congestion to indicate to the UE that the procedure over the satellite access is interrupted, wherein the message is non-integrity protected, and wherein the message further indicates to the UE a minimum time to wait before reattempting the procedure, and wherein the reattempting to complete the procedure responsive to the condition being met comprises, at expiry of a timer, starting the procedure with the cell or another cell.

20. The apparatus of claim 19, wherein the receiving of the message comprises receiving the message over the satellite access without integrity protection, wherein the message provides a timer T3346 value, and wherein the starting of the procedure comprises:
starting a timer with the T3346 value provided by the network; and
starting the procedure at expiry of the timer.
